(19) United States
(12) Patent Application Publication
(10) Pub. No.: US 2026/0190172 A1
(43) Pub. Date: Jul. 2, 2026

(54) HANDLING OF SESSION SYNCHRONIZATION BETWEEN THE USER EQUIPMENT AND THE NETWORK

(71) Applicant: GOOGLE LLC, Mountain View, CA (US)

(72) Inventors: Sang Min Park, Mountain View, CA (US); JJ HuangFu, Mountain View, CA (US)

(21) Appl. No.: 19/439,040

(22) Filed: Jan. 2, 2026

Related U.S. Application Data
(60) Provisional application No. 63/741,415, filed on Jan. 2, 2025.

(51) Int. Cl. H04W 76/18; H04W 56/00

(52) U.S. Cl. CPC H04W 76/18; H04W 56/00

(57) ABSTRACT

To synchronize the status of a data connection with a user equipment, a node of a core network (CN) receiving, from the UE, a non-access stratum (NAS) request message (650). In response to determining (660) to reject the NAS request, the node of the Cn transmits (670), to the UE, a status of the data connection between the UE and the CN.

### TECHNICAL FIELD

This disclosure relates generally to wireless communication and some aspects relate to session management (SM) synchronization between a UE (User Equipment) and a network.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Generally speaking, a base station operating a cellular radio access network (RAN) communicates with a user equipment (UE) using a certain radio access technology (RAT) and multiple layers of a protocol stack. For example, the physical layer (PHY) of a RAT provides transport channels to the Medium Access Control (MAC) sublayer, which in turn provides logical channels to the Radio Link Control (RLC) sublayer, and the RLC sublayer in turn provides data transfer services to the Packet Data Convergence Protocol (PDCP) sublayer. The Radio Resource Control (RRC) sublayer is disposed above the PDCP sublayer.

The RRC sublayer specifies the RRC_IDLE state, in which a UE does not have an active radio connection with a base station and does not store a UE access stratum (AS) context; the RRC_CONNECTED state, in which the UE has an active radio connection with the base station; and the RRC_INACTIVE to allow a UE to more quickly transition back to the RRC_CONNECTED state due to Radio Access Network (RAN)-level base station coordination and RAN-paging procedures. Depending on different implementations or scenarios, the base station can configure Small Data Transmission (SDT) for the UE operating in the RRC_INACTIVE to transmit one or more small packets.

The UE may establish more than one Evolved Packet System (EPS) bearer or Packet Data Unit (PDU) session, and Session Management (SM) functionality includes management of these bearers or sessions. In a core network (CN), an entity dedicated to SM, such as a Packet Data Network Gateway (PGW) or a Session Management Function (SMF) manages data sessions of the UE. To manage the establishment, modification, and release of EPS bearer/PDU sessions, the PGW/SMF and a UE use a non-access stratum (NAS) SM protocol, at the NAS layer. When the UE is in a connected mode (e.g., ECM-CONNECTED or EMM-CONNECTED for the UE and the CN in the EPS; or CM-CONNECTED or 5GMM-CONNECTED for the UE and the CN in the 5GS), SM procedures manage EPS bearers/PDU sessions.

When the UE is in the idle mode (e.g., ECM-IDLE or EMM-IDLE for the UE and the CN in the EPS or CM-IDLE or 5GMM-IDLE for the UE and the CN in the 5GS), either the UE or the CN may release one or more EPS bearers/PDU sessions “locally,” without explicit signaling. This ability to unilaterally release a bearer or a session can result in the UE and the CN understanding the status of EPS bearers and PDU sessions differently. To synchronize the status of EPS bearers/PDU sessions, the UE and the CN exchange the status of EPS bearers/PDU sessions during the NAS MM procedure (e.g., tracking area update procedure, registration update procedure, or service request procedure) that occurs next. More specifically, the UE includes, in a message, a bitmap of current EPS bearers/PDU sessions, and the CN similarly indicates the CN-side status of the EPS bearers/PDU sessions, after updating the CN-side data using the received status of the UE. The current format of the status according to the implementation specified in TS 24.301 and TS 24.501 follows:

TABLE 1
EPS bearer context status IE in TS 24.301

| 8 | 7 | 6 | 5 | 4 | 3 | 2 | 1 | |
|---|---|---|---|---|---|---|---|---|
| EPS bearer context status IEI | | | | | | | | octet 1 |
| Length of EPS bearer context status contents | | | | | | | | octet 2 |
| EBI | EBI | EBI | EBI | EBI | EBI | EBI | EBI | octet 3 |
| (7) | (6) | (5) | (4) | (3) | (2) | (1) | (0) | |
| EBI | EBI | EBI | EBI | EBI | EBI | EBI | EBI | octet 4 |
| (15) | (14) | (13) | (12) | (11) | (10) | (9) | (8) | |

EBI(x) shall be coded as follows:
EBI(0):
Bit 1 of octet 3 is spare and shall be coded as zero.
EBI(1)-EBI(15):
0 indicates that the ESM state of the corresponding EPS bearer context is BEARER CONTEXT- INACTIVE.
1 indicates that the ESM state of the corresponding EPS bearer context is not BEARER CONTEXT- INACTIVE

TABLE 2
PDU session status IE in TS 24.501

| 8 | 7 | 6 | 5 | 4 | 3 | 2 | 1 | |
|---|---|---|---|---|---|---|---|---|
| PDU session status IEI | | | | | | | | octet 1 |
| Length of PDU session status contents | | | | | | | | octet 2 |
| PSI | PSI | PSI | PSI | PSI | PSI | PSI | PSI | octet 3 |
| (7) | (6) | (5) | (4) | (3) | (2) | (1) | (0) | |
| PSI | PSI | PSI | PSI | PSI | PSI | PSI | PSI | octet 4 |
| (15) | (14) | (13) | (12) | (11) | (10) | (9) | (8) | |
| 0 | 0 | 0 | 0 | 0 | 0 | 0 | 0 | octet 5*-34* |
| spare | | | | | | | | |

PSI(x) shall be coded as follows:
PSI(0):
Bit 1 of octet 3 is spare and shall be coded as zero.
PSI(1)-PSI(15):
0 indicates that the 5GSM state of the corresponding PDU session is PDU SESSION INACTIVE.
1 indicates that the 5GSM state of the corresponding PDU session is not PDU SESSION INACTIVE
All bits in octet 5 to 34 are spare and shall be coded as zero, if the respective octet is included in the information element.

If the UE includes the EPS bearer context status IE or the PDU session status IE in a UL NAS request message, which is an initial NAS request message, the CN responds with the corresponding initial NAS accept message.

However, the CN may not accept a NAS request from the UE due to one of the reasons specified in TS 24.301 and TS 24.501. These reasons include congestion, a temporary issue, and a localized issue. When the CN detects one of these conditions, the CN cannot respond to the request to align the EPS bearer/PDU session status between the UE and the CN.

### SUMMARY

A node in a CN indicates, to a UE when rejecting a request from the UE, the status of a data connection such as an EPS bearer to a Packet Data Network (PDN), a PDU session, or any other suitable logical connection between the UE and a data network. Depending on the implementation or scenario, the CN includes the synchronization information in a message rejecting the request or another downlink message. In some implementations, the synchronization information pertains to multiple data connections.

An example embodiment of these techniques of this disclosure is a method for synchronizing a status of a data connection. The method is implemented in a node of a core network (CN) and comprises receiving, from a user equipment (UE), a non-access stratum (NAS) request message; and in response to determining to reject the NAS request, transmitting, to the UE, a status of the data connection between the UE and the CN.

Another example embodiment of these techniques is a method for synchronizing a data connection. The method is implemented in UE and comprises transmitting, to a CN, a NAS request message; receiving, from the CN and in response to the NAS request message, a NAS reject message including the status of the data connection between the UE and the CN; and updating, using the status of the data connection received from the CN, a UE status of the data connection.

Another example embodiment of these techniques is an apparatus comprising processing hardware and configured to implement one of the methods above.

### BRIEF DESCRIPTION OF THE DRAWINGS

FIG. 1A is a block diagram of an example wireless communication system in which a user device and a base station of this disclosure can implement the paging techniques of this disclosure;

FIG. 1B is a block diagram of an example base station in which a centralized unit (CU) and a distributed unit (DU) that can operate in the system of FIG. 1A;

FIG. 2A is a block diagram of an example protocol stack according to which the UE of FIG. 1A communicates with base stations;

FIG. 2B is a block diagram of an example protocol stack according to which the UE of FIG. 1A communicates with a CU and a DU;

FIG. 3A illustrates an example control plane protocol stack for use with the architecture of FIG. 1A, particularly within the 5G System (5GS);

FIG. 3B illustrates an example control plane protocol stack for use with the architecture of FIG. 1A, particularly within the Evolved Packet System (EPS);

FIG. 4 illustrates an example scenario in which a UE obtains an indication of whether the UE is allowed to synchronize the status of a data connection via a reject message;

FIG. 5A illustrates an example scenario in which a CN provides the status of a data connection via a reject message;

FIG. 5B illustrates an example scenario generally similar to that of FIG. 5A, but in which the CN provides the status of a data connection in a message separate from the reject message;

FIG. 6 is a flow diagram of an example method for synchronizing the status of a data connection when rejecting a request from a UE, which can be implemented in a CN of FIG. 1A; and

FIG. 7 is a flow diagram of an example method for synchronizing the status of a data connection when the CN rejects the request from a UE of FIG. 1A, which can be implemented in the UE.

### DETAILED DESCRIPTION

As discussed in more detail below, a user equipment (UE) and/or a network node of a radio access network (RAN) can use the techniques of this disclosure for managing early data communication and transitioning a UE between states of a protocol for controlling radio resources between the UE and the RAN.

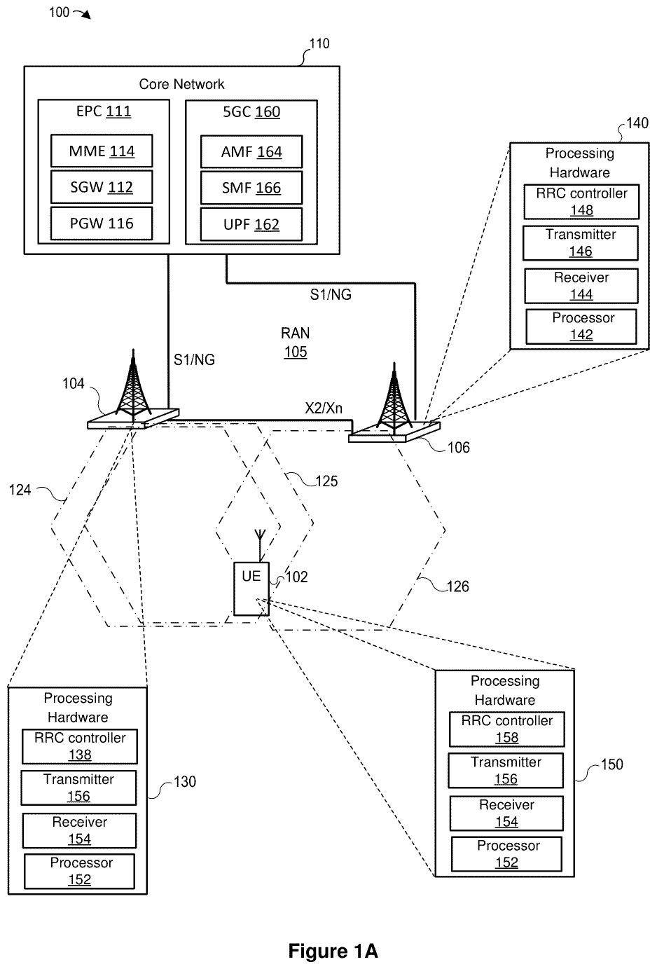

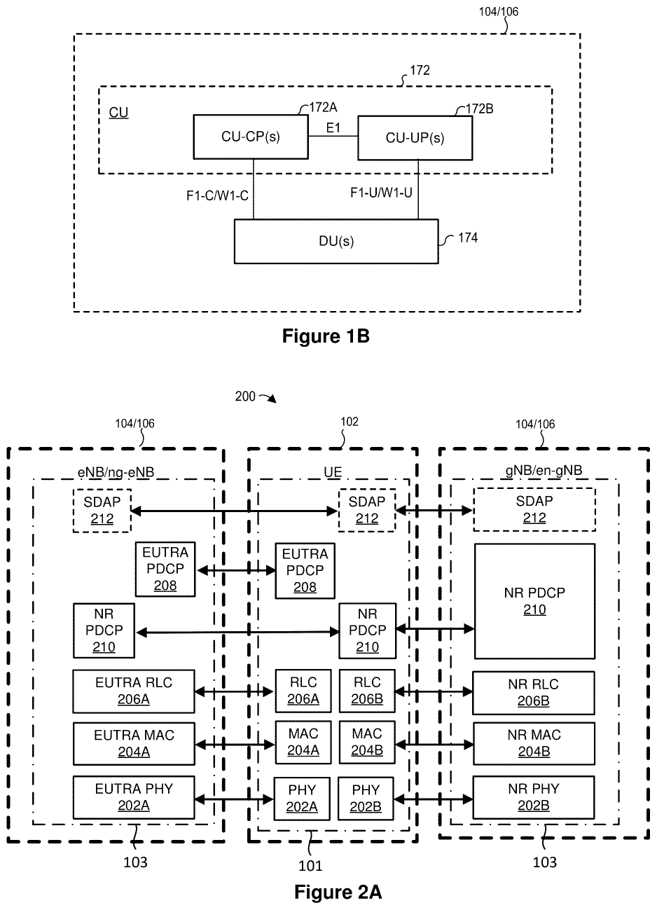

Referring first to FIG. 1A, an example wireless communication system 100 includes a UE 102, a base station (BS) 104, a base station 106, and a core network (CN) 110. The base stations 104 and 106 can operate in a RAN 105 connected to the core network (CN) 110. The CN 110 can be implemented as an evolved packet core (EPC) 111 or a fifth generation (5G) core (5GC) 160, for example. The CN 110 can also be implemented as a sixth generation (6G) core in another example.

The base station 104 covers a cell 124, and the base station 106 covers a cell 126. If the base station 104 is a gNB, the cell 124 is an NR cell. If the base station 104 is an ng-eNB or eNB, the cell 124 is an evolved universal terrestrial radio access (E-UTRA) cell. Similarly, if the base station 106 is a gNB, the cell 126 is an NR cell, and if the base station 106 is an ng-eNB or eNB, the cell 126 is an E-UTRA cell. The cells 124 and 126 can be in the same Radio Access Network Notification Areas (RNA) or different RNAs. In general, the RAN 105 can include any number of base stations, and each of the base stations can cover one, two, three, or any other suitable number of cells. The UE 102 can support at least a 5G NR (or simply, “NR”) or E-UTRA air interface to communicate with the base stations 104 and 106. Each of the base stations 104, 106 can connect to the CN 110 via an interface (e.g., S1 or NG interface). The base stations 104 and 106 also can be interconnected via an interface (e.g., X2 or Xn interface) for interconnecting NG RAN nodes.

Among other components, the EPC 111 can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management Function (AMF) 164, and/or Session Management Function (SMF) 166. Generally speaking, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions.

As illustrated in FIG. 1A, the base station 104 supports a cell 124, and the base station 106 supports a cell 126. The cells 124 and 126 can partially overlap, so that the UE 102 can select, reselect, or hand over from one of the cells 124 and 126 to the other. To directly exchange messages or information, the base station 104 and base station 106 can support an X2 or Xn interface. In general, the CN 110 can connect to any suitable number of base stations supporting NR cells and/or EUTRA cells.

As discussed in detail below, the UE 102 and/or the RAN 105 may utilize the techniques of this disclosure when the radio connection between the UE 102 and the RAN 105 is suspended, e.g., when the UE 102 operates in an inactive or idle state of the protocol for controlling radio resources between the UE 102 and the RAN 105. For clarity, the examples below refer to the RRC_INACTIVE or RRC_IDLE state of the RRC protocol.

The base station 104 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 in an example implementation includes a processor 132 to process data that the base station 104 will transmit in the downlink direction, or process data received by the base station 104 in the uplink direction. The processing hardware 130 can also include a transmitter 136 configured to transmit data in the downlink direction. The processing hardware further can include a receiver 134 configured to receive data in the uplink direction. The processing hardware further can include an RRC controller 138 to implement procedures and messaging at the RRC sublayer of the protocol communication stack. The base station 106 can include generally similar components. In particular, components 140, 142, 144, 146, and 148 of the base station 106 can be similar to the components 130, 132, 134, 136, and 138 respectively.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes a processor 152 to process data that the UE 102 will transmit in the uplink direction, or process data received by UE 102 in the downlink direction. The processing hardware 150 can also include a transmitter 156 configured to transmit data in the downlink direction. The processing hardware further can include a receiver 154 configured to receive data in the uplink direction. The processing hardware further can include an RRC controller 158 to implement procedures and messaging at the RRC sublayer of the protocol communication stack.

FIG. 1B depicts an example distributed or disaggregated implementation of any one or more of the base stations 104, 106. In this implementation, the base station 104, 106 includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include a PDCP controller, an RRC controller and/or an RRC inactive controller. In some implementations, the CU 172 can include a radio link control (RLC) controller configured to manage or control one or more RLC operations or procedures. In further implementations, the CU 172 does not include an RLC controller.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a MAC controller configured to manage or control one or more MAC operations or procedures (e.g., a random access procedure), and/or an RLC controller configured to manage or control one or more RLC operations or procedures. The process hardware can also include a physical layer controller configured to manage or control one or more physical layer operations or procedures.

In some embodiments, the RAN 105 supports Integrated Access and Backhaul (IAB) functionality. In some implementations, the DU 174 operates as an IAB-node, and the CU 172 operates as an IAB-donor. In some embodiments, the RAN 105 supports Non-Terrestrial Network (NTN) functionality.

In some implementations, the CU 172 can include a logical node CU-CP 172A that hosts the control plane part of the PDCP protocol of the CU 172. The CU 172 can also include logical node(s) CU-UP 172B that hosts the user plane part of the PDCP protocol and/or Service Data Adaptation Protocol (SDAP) protocol of the CU 172. The CU-CP 172A can transmit control information (e.g., RRC messages, F1 application protocol messages), and the CU-UP 172B can transmit the data packets (e.g., SDAP PDUs or Internet Protocol packets).

The CU-CP 172A can be connected to multiple CU-UP 172B through the E1 interface. The CU-CP 172A selects the appropriate CU-UP 172B for the requested services for the UE 102. In some implementations, a single CU-UP 172B can connect to multiple CU-CP 172A through the E1 interface. The CU-CP 172A can connect to one or more DU 174s through an F1-C interface. The CU-UP 172B can connect to one or more DU 174 through the F1-U interface under the control of the same CU-CP 172A. In some implementations, one DU 174 can connect to multiple CU-UP 172B under the control of the same CU-CP 172A. In such implementations, the connectivity between a CU-UP 172B and a DU 174 is established by the CU-CP 172A using Bearer Context Management functions.

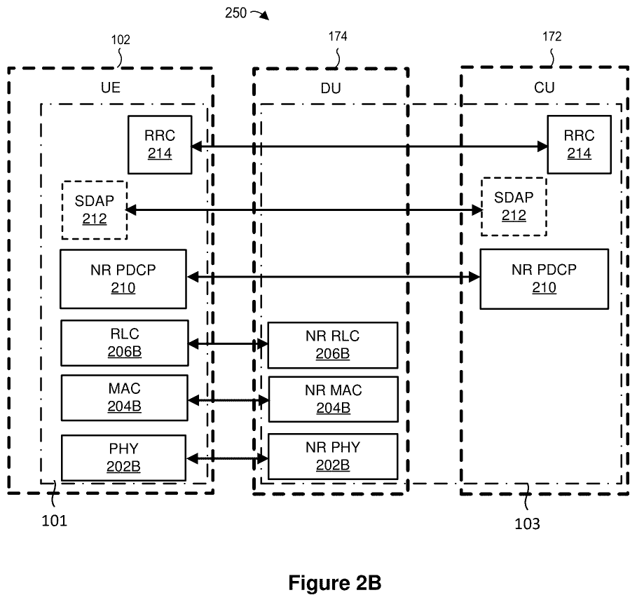

FIG. 2A illustrates, in a simplified manner, an example protocol stack 200 according to which the UE 102 can communicate with an eNB/ng-eNB or a gNB (e.g., one or more of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to an EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to Service Data Adaptation Protocol (SDAP) 212 or a radio resource control (RRC) sublayer (not shown in FIG. 2A). The UE 102, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) or RRC sublayer (not shown in FIG. 2A) to exchange RRC messages or non-access-stratum (NAS) messages, for example. On a user plane, the EUTRA PDCP sublayer 208 and the NR PDCP sublayer 210 can provide Data Radio Bearers (DRBs) to support data exchange. Data exchanged on the NR PDCP sublayer 210 can be SDAP PDUs, Internet Protocol (IP) packets or Ethernet packets.

FIG. 2B illustrates, in a simplified manner, an example protocol stack 250, which the UE 102 can communicate with a DU (e.g., DU 174) and a CU (e.g., CU 172). The radio protocol stack 200 is functionally split as shown by the radio protocol stack 250 in FIG. 2B. The CU at any of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

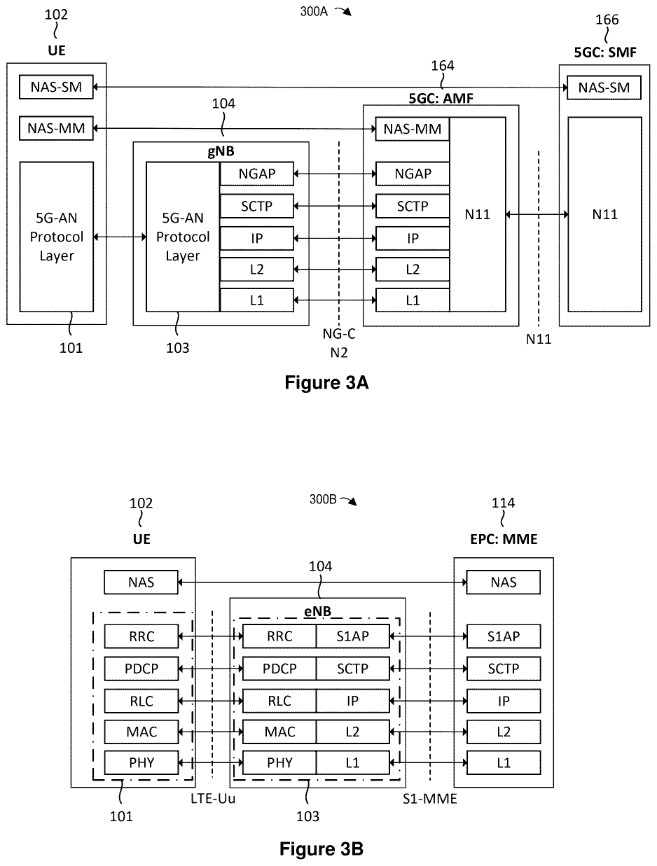

The control plane protocol stack of the 5GS involving the UE 102, the gNB 104, the AMF 164 and the SMF 165 is illustrated in FIG. 3A. Generally speaking, a NAS protocol manages the UE's mobility, session, and control plane signaling between the UE 102 and the CN 110, transparent to any 5G access network node 104 (e.g. gNB or eNB). For the 5G CN type, two network entities are responsible as endpoints of NAS protocol in the CN side, which are AMF 164 and SMF 166. The AMF 164 is responsible for managing the UE's mobility and connection to the CN 110. Also any upper layer control signal can be delivered over NAS layer between the AMF 164 and the UE 102, which is also called NAS-MM layer. The SMF 166 is responsible for managing PDU sessions, and a UE 102 can be associated with one or more SMFs 166 at the same time. The NAS protocol between the UE 102 and the SMF 166 is also called NAS-SM layer.

The control plane protocol stack of the EPS involving the UE 102, the eNB 104, and the MME 114 is illustrated in FIG. 3B. Similar to the 5GS control plane protocol stack in the FIG. 3A, a NAS protocol manages the UE's mobility, session, and control plane signaling between the UE 102 and the CN 110, transparent to any LTE access network node 104 (e.g. eNB or gNB). EPC has a single endpoint for the NAS protocol in the network side, which is an MME 114. The MME 114 is responsible for both mobility management and session management aspects, although SM related protocols assumes to be upper to MM related protocols.

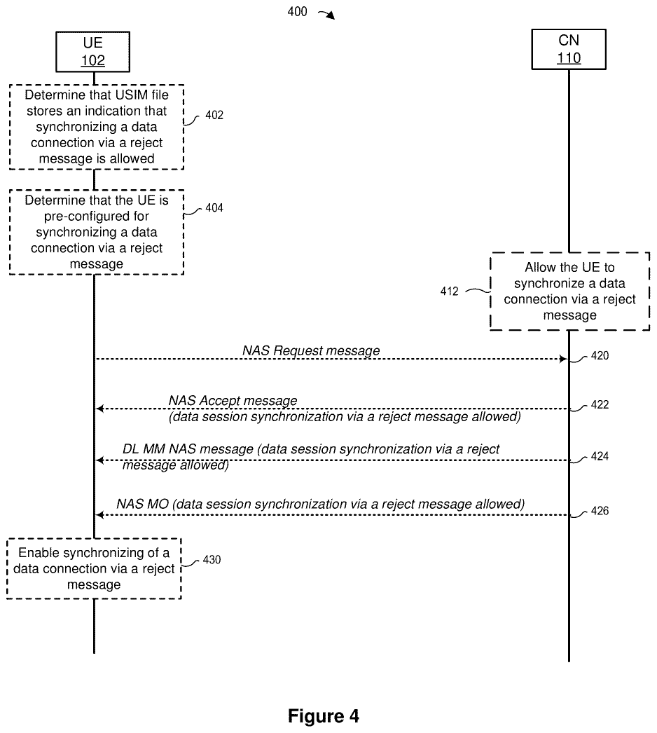

Next, several example scenarios that involve several components of FIG. 1A and relate to synchronization of a status of a bearer or a session are discussed next with reference to FIGS. 4-7. Generally speaking, similar events or blocks in FIGS. 4-7 are labeled with the same or similar reference numbers, with differences discussed below where appropriate. With the exception of the differences shown in the figures and discussed below, any of the alternative implementations discussed with respect to a particular event (e.g., for messaging and processing) may apply to events labeled with similar reference numbers in other figures and also to both integrated and distributed base stations.

In at least some of the scenarios discussed below, “data connection synchronization” refers to PDN synchronization or PDU session synchronization.

Referring first to a scenario 400 illustrated in FIG. 4, a node in a core network (CN) (such as the MME 111, the AMF 164, or a node dedicated specifically to managing data connections with UEs), an operator, or an authorized third party configures the UE 102 for synchronization of a data connection such as an EPS bearer or a PDU session via a reject message. In some cases, the UE 102 obtains multiple indications of whether the UE 102 is allowed to synchronize a data connection via a reject message, and determines which of the multiple indications the UE 102 should apply based on the relative timing of the indications of a predetermined ranking of priorities, for example.

In one example implementation or scenario, the UE 102 retrieves 402, from a Universal Subscriber Identity Module (USIM), an indication that the UE 102 is allowed to synchronize data connections via a reject message. The indication can be for example a certain NAS configuration parameter.

Alternatively or additionally, the UE 102 determines 404 that the manufacturer of the UE 102 or an operator has pre-configured the UE 102 with a permission to synchronize data connections via reject messages. In one such implementation, the manufacturer or the operator stores an appropriate indication in the persistent memory of the UE 102.

In another such implementation, the CN 110 transmits, to the UE 102, a local configuration including this indication or a session-specific indication. More specifically, the CN 110 determines 410 that the UE 102 is allowed to synchronize a data connection via a reject message and indicates this permission via one or more DL NAS messages. To this end, the UE 102 can transmit a 420 NAS request message to CN 110, in an uplink (UL) direction.

The NAS request message can be an ATTACH REQUEST, TRACKING AREA UPDATE REQUEST, REGISTRATION REQUEST, or SERVICE REQUEST message. In response, the CN 110 transmits 422 a NAS accept message, in a downlink (DL) direction. In some implementations, the NAS accept message can be an ATTACH ACCEPT, TRACKING AREA UPDATE ACCEPT, REGISTRATION ACCEPT, or SERVICE ACCEPT message. The NAS accept message may include an indication of whether the UE is allowed to synchronize a data session via a reject message.

Alternatively, the CN 110 can transmit 424 an indication of whether the UE 102 is allowed to synchronize a data session via a reject message in message associated with a NAS mobility management (MM) procedure, such as for example an MM common procedure. The message associated with the NAS MM procedure can be a GUTI REALLOCATION COMMAND or CONFIGURATION UPDATE COMMAND message, for example.

As yet another alternative, the CN 110 can update the configuration of the UE 102 by transmitting 426 a NAS MO (Management Object) update message. The transmission 426 of the configuration can indicate a permission, or lack of permission, for the UE 102 to synchronize a data session via a reject message.

An indication of whether the UE 102 is allowed to synchronize a data session via a reject message, included 422, 424, or 426 in a downlink message from the CN 110, can be a dedicated IE (Information Element) such as “data session synchronization via a reject message,” “PDU synchronization via a reject message,” or “EPS bearer synchronization via a reject message.” The IE can be a binary flag or, to provide more granularity, an IE with one flag indicating a permission (or lack of permission) to synchronize an EPS bearer via a reject message and another flag indicating a permission (or lack of permission) to synchronize a PDU session via a reject message. In other implementations, another IE carrying configuration for the UE 102 includes one or more flags indicating whether the UE can synchronize a data connection via a reject message.

Thus, the UE 102 can obtain an indication of whether the UE 102 can synchronize a data connection via a reject message via determination 402 or 404, and/or by receiving 422, 424, or 426 a downlink NAS message. If the UE 102 obtains multiple such indications, e.g., if the UE 102 detects 404 a lack of permission synchronize a data connection via a reject message according to the prestored configuration but also receives 424 a DL MM NAS message with a permission to synchronize a data connection via a reject message, the UE 102 can apply the last received indication, which in this example if the permission included 424 in the DL MM NAS message. Alternatively, the UE 102 can enforce a certain hierarchy of indications, e.g., the CN 110 overrides the USIM setting but not the pre-configuration from the operator, or the CN 110 overrides the USIM setting as well as the pre-configuration from the operator, or the USIM setting takes priority over any NAS message from the CN 110.

In the example scenario 400, the UE 102 enables 430 synchronizing of a data connection via a reject message after one or more of the determining 402, the determining 404, the receiving 422, the receiving 424, or the receiving 426.

Further, in some implementations, the UE 102 provides, to the CN 110, an indication of whether the UE 102 has enabled synchronization of a data connection via a reject message, at a suitable opportunity.

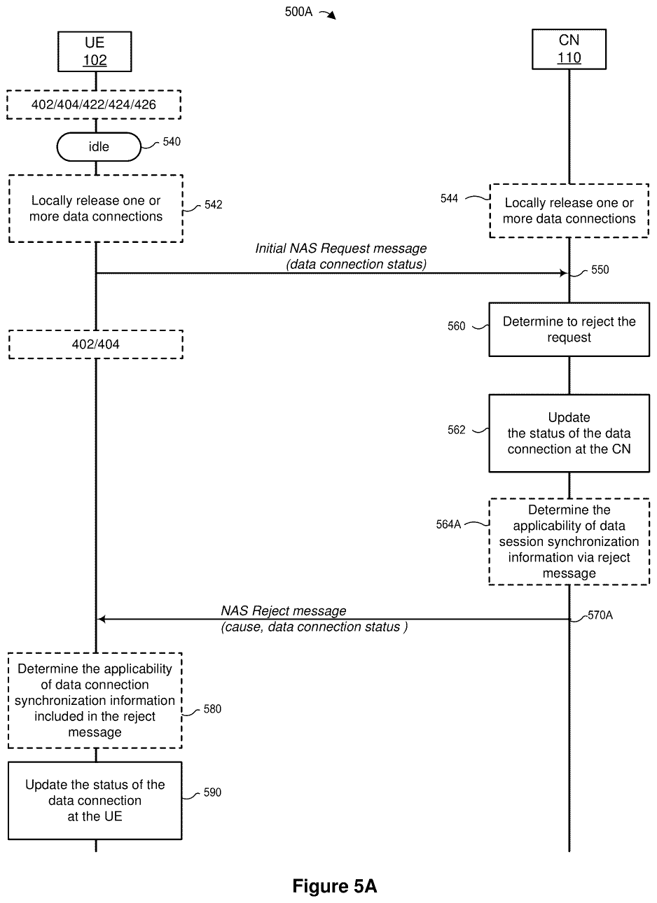

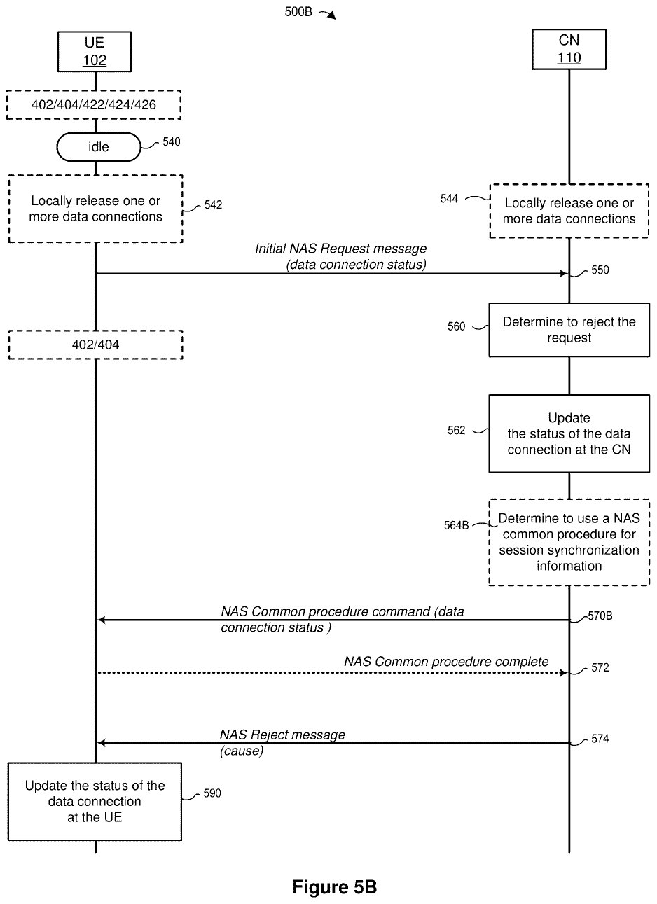

Now referring to FIG. 5A, in a scenario 500A, the UE 102 initially operates in idle mode 540. While the UE 102 is in idle mode, the UE 102 may locally release 542 one or more data connections, such as EPS bearers or PDU sessions, without explicit signaling with the CN 110. The CN 110 also can locally release 544 one or more data connections without explicit signaling with the UE 102, at the same time or a different time, and in response to a generally similar local signal (e.g., timer expiration) or a different signal (e.g., a command from a data network).

At a later time, the UE 102 initiates a NAS procedure by sending an initial NAS request message 550. A trigger event for transmitting 550 the NAS request message can be, for example, a decision to align the status of a data connection (e.g., an EPS bearer, a PDU session) with the CN 110. More generally, the UE 102 can transmit 550 the NAS request message for any suitable reason. The UE 102 can include, in the initial NAS request message, the status of the data connection, such as an EPS bearer context status IE or a PDU session status IE. In some scenarios, the NAS request message includes respective statuses of multiple data connections.

After the CN 110 receives 550 the NAS request message, the CN 110 can determine 560 to reject the request due to one or more reasons, such as for example network congestion or determining that the UE is not currently in an allowed area of service.

Rather than discarding the status of the data connection (or multiple data connections), the CN 110 updates 562 the current status of the data connection at the CN 110, even though the CN 110 has already determined to reject the request. In this manner, the CN 110 reduces the probability of misalignment between the statuses of the data connection at the UE 102 and the CN 110, and/or eliminates the need for the UE 102 or the CN 110 to initiate another message exchange in order to align the statuses.

If the NAS request message refers to one or more EPS bearers or PDU sessions (or other data connections) that are active in the CN 110, and if the NAS request message marks these as inactive at the UE in the EPS bearer context status or the PDU session status IE, the CN 110 can also release these one or more EPS bearers, PDU sessions, or data connection of other types. In some implementations, the node of CN 110 that receives 550 the NAS request message interacts with other CN nodes such as a Session Management Function (SMF), a User Plane Function (UPF), a Serving Gateway (SGW), and/or a PGW to release the inactive sessions.

The CN 110 may determine 564A whether the UE 102 is allowed to use data session synchronization via a reject message. In some implementations, the applicability is based on the subscription of the UE 102. In other implementations, the applicability is subject to the relevant operator policy. In yet other implementations, the applicability is based on whether the CN 110 and the UE 102 have established a valid security context, e.g., whether the UE 102 and the CN 110 can exchange integrity-protected messages. If the CN 110 determines 564A that the UE 102 is allowed to synchronize a data session via a reject message, as is the case in the example scenario of FIG. 5A, the CN 110 sends 570A a NAS reject message to the UE 102 with a data connection status such as an EPS bearer context status IE or a PDU session status IE. If the CN 110 determines 564A that the UE 102 is not allowed to synchronize a data connection via a reject message, the CN 110 can refrain from including the data connection status in the NAS rejection message.

After the UE 102 receives 570A the NAS reject message, and when the NAS reject message includes a data connection status such as an EPS bearer context status IE or a PDU session status IE, the UE determines 580 whether the UE 102 can accept (process or apply) the contents of the IE. In some scenarios, the UE 102 determines to accept the data connection status included in the NAS reject message. To this end, the UE 102 can implement one of the techniques discussed with reference to FIG. 4. Events 402, 404, 422, 424, or 426 can occur prior to the UE 102 entering 540 the idle state or after the UE 102 determining 542 to locally release one or more data connections and prior to transmitting 550 the initial NAS request message, for example. Further, event 402 or 404 can occur at any suitable time, such as for example after transmitting 550 the initial NAS request message and prior to receiving 570A the NAS reject message.

If the UE 102 is allowed to synchronize a data session via reject message, then the UE 102 determines 580 that the UE 102 should accept the contents of the received IE and update 590 the status of an EPS bearer context, a PDU session status, or another data connection accordingly.

In some implementations, the UE 102 determines 580 to accept the data connection status received 570A in the NAS reject message only if this message is integrity-protected. If the reject message is not integrity-protected, or if the integrity check of the reject message fails, the UE 102 discards or ignores the data connection status received 570A in the reject message.

If the UE 102 determines 580 to accept the contents of the received IE, the UE 102 updates 590 the current status of the data connection at the UE 102. If the reject message indicates as “inactive” at the CN 110, in the corresponding IE, one or more data connections that are active at the UE 102 when the UE 102 receives 570A the reject message, the UE 102 can also release these data connections (e.g., EPS bearers or PDU sessions).

Referring next to FIG. 5B, a scenario 500B is generally similar to the scenario 500A, except that the scenario 500B includes events 564B, 570B, 572 and 574 instead of events 564A, 570A and 580. In this scenario, the CN 110 similarly receives 550 a NAS request message, determines 560 to reject the request, and updates 562, at the CN 110, the current status of the one or more data connections to which the NAS request message refers.

However, in this scenario the CN 110 determines 564B to update the status of the one or more connections at the UE 102 via a NAS common procedure. Depending on the implementation or scenario, this NAS common procedure can be a GUTI reallocation procedure or a UE configuration update procedure. Generally, the CN 110 can perform a NAS common procedure in conjunction with other NAS procedures including NAS specific procedures such as attach, registration, tracking area update or service request procedure.

In particular, the CN 110 sends 570B a NAS common procedure command message to the UE 102, including the data connection status (an EPS bearer context status IE, a PDU session status IE). In some scenarios, the NAS common procedure command message is a GUTI REALLOCATION COMMAND or CONFIGURATION UPDATE COMMAND message. After receiving 570B the NAS common procedure command message, the UE 102 may send 572, to the CN 110, a NAS common procedure complete message to acknowledge the receipt of the NAS common procedure command message. In some implementations, the NAS common procedure complete message is a GUTI REALLOCATION COMPLETE or CONFIGURATION UPDATE COMPLETE message. The UE 102 updates 590 the local status of data connection(s), such as the current EPS bearer context status or a PDU session status, accordingly. The CN 110 sends 574, to the UE 102, a NAS reject message after sending 570B the NAS common procedure command message.

Thus, the scenario of FIG. 5B advantageously eliminates the need for the UE 102 to support, or have permissions to process, the status of a data connection in a reject message. Nevertheless, the technique of FIG. 5B allows the UE 102 and the CN 110 to synchronize the statuses of one or more data connections even when the CN 110 rejects the NAS request from the UE 102. However, the technique of FIG. 5B involves more messaging than the technique of FIG. 5A.

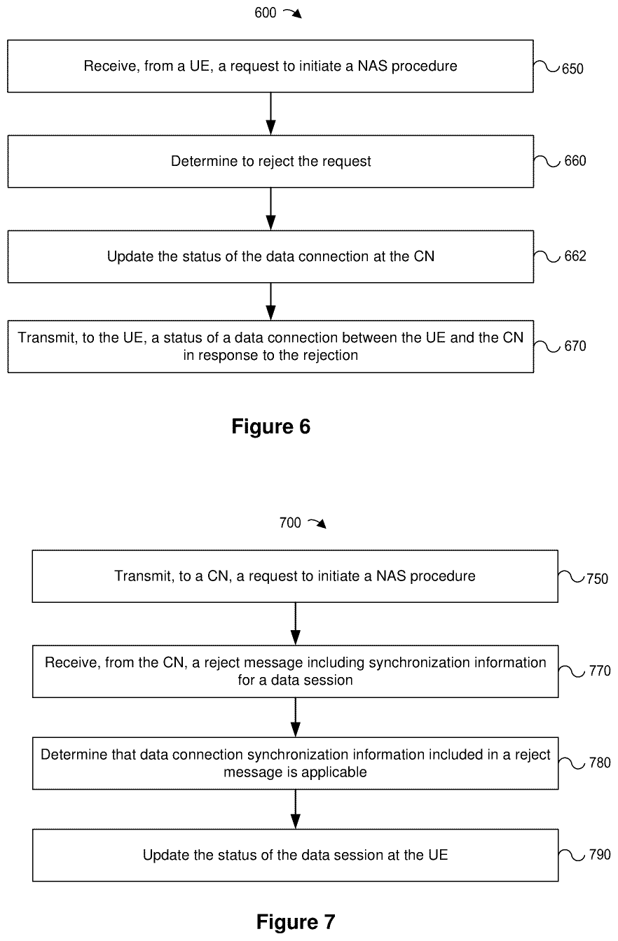

FIG. 6 illustrates a flow diagram of an example method 600, which a node in the CN 110 for example can implement to synchronize the status of a data connection with a UE, such as the UE 102, even when the node rejects the NAS request that indicates the current status of the data connection at the UE.

At block 650, the node receives, from the UE, a request to initiate a NAS procedure (e.g., event 550). At block 660, the node determines to reject the request (e.g., event 560). Next, at block 662, the node updates the (local) status of the data connection at the CN (e.g., event 560). Finally, at block 670, the node transmits, to the UE, the status of the data connection (event 570A or 570B).

FIG. 7 illustrates a flow diagram of an example method 700, which a UE such as the UE 102 can implement to synchronize the status of a data connection with a CN, even when the node rejects the NAS request that indicates the current status of the data connection at the UE.

At block 750, the node transmits, to the CN, a request to initiate a NAS procedure (e.g., event 550). At block 770, the UE receives, from the CN, the status of the data connection (event 570A or 570B). At block 780, the UE determines that the data connection synchronization information in the reject message is applicable (e.g., event 580). Finally, at block 790, the UE updates the (local) status of the data connection at the UE (e.g., event 590).

The operations described herein are examples meant to aid in understanding example implementations and should not be used to limit the potential implementations or limit the scope of the claims. Some implementations may perform additional operations, fewer operations, operations in parallel or in a different order, and some operations differently.

Another innovative aspect of the subject matter described in this disclosure can be implemented as a computer-readable medium having stored therein instructions which, when executed by a processor, causes the processor to perform any one of the above-mentioned functionalities.

Another innovative aspect of the subject matter described in this disclosure can be implemented as a system having means for implementing any one of the above-mentioned functionalities.

Another innovative aspect of the subject matter described in this disclosure can be implemented as an apparatus having one or more processors configured to perform one or more operations from any one of the above-mentioned methods.

The following description may be applied to the description above.

Generally speaking, description for one of the above figures can apply to another of the above figures. Examples, implementations and methods described above can be combined, if there is no conflict. An event or block described above can be optional or omitted. For example, an event or block with dashed lines in the figures can be optional. In some implementations, “message” is used and can be replaced by “information element (IE),” and vice versa. In some implementations, “IE” is used and can be replaced by “field,” and vice versa. In some implementations, “configuration” can be replaced by “configurations” or “configuration parameters,” and vice versa. In some implementations, “some” means “one or more.” In some implementations, “at least one” means “one or more.”

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

Upon reading this disclosure, those of skill in the art will appreciate additional and alternative structural and functional designs for handling mobility between base stations through the principles disclosed herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

As used herein, the terms “component” and “module” are intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.”

As used herein, a phrase referring to a list of items separated by “or” refers to any combination of those items, including single members. For example, “a, b, or c” is intended to cover the possibilities of: a only, b only, c only, a combination of a and b, a combination of a and c, a combination of b and c, and a combination of a and b and c.

In this disclosure, the term “can” indicates a capability, or alternatively indicates a possible implementation option. The term “may” indicates a permission or a possible implementation option.

Some aspects are described herein in connection with thresholds. As used herein, satisfying a threshold may refer to a value being greater than the threshold, greater than or equal to the threshold, less than the threshold, less than or equal to the threshold, equal to the threshold, not equal to the threshold, or the like.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus used to implement the various illustrative components, logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, or any conventional processor, controller, microcontroller, or state machine. A processor also may be implemented as a combination of computing devices, for example, a combination of a DSP and a microprocessor, multiple microprocessors, one or more microprocessors in conjunction with a DSP core, or any other such configuration. In some implementations, particular processes, operations and methods may be performed by circuitry that is specific to a given function.

As described above, some aspects of the subject matter described in this specification can be implemented as software. For example, various functions of components disclosed herein, or various blocks or steps of a method, operation, process or algorithm disclosed herein can be implemented as one or more modules of one or more computer programs. Such computer programs can include non-transitory processor-executable or computer-executable instructions encoded on one or more tangible processor-readable or computer-readable storage media for execution by, or to control the operation of, a data processing apparatus including the components of the devices described herein. By way of example, and not limitation, such storage media may include RAM, ROM, EEPROM, CD-ROM or other optical disk storage, magnetic disk storage or other magnetic storage devices, or any other medium that may be used to store program code in the form of instructions or data structures. Combinations of the above should also be included within the scope of storage media.

As used herein, the terms “user device”, “user equipment” (for example, UE 110), “wireless communication device”, “mobile communication device”, “communication device”, or “mobile device” refer to any one or all of cellular telephones, smartphones, portable computing devices, personal or mobile multi-media players, laptop computers, tablet computers, smartbooks, Internet-of-Things (IoT) devices, palm-top computers, wireless electronic mail receivers, multimedia Internet enabled cellular telephones, wireless gaming controllers, display sub-systems, driver assistance systems, vehicle controllers, vehicle system controllers, vehicle communication system, infotainment systems, vehicle telematics systems or subsystems, vehicle display systems or subsystems, vehicle data controllers, point-of-sale (POS) terminals, health monitoring devices, drones, cameras, media-streaming dongles or another personal media devices, wearable devices such as smartwatches, wireless hotspots, femtocells, broadband routers or other types of routers, and similar electronic devices which include a programmable processor and memory and circuitry configured to perform operations as described herein. Further, the user device in some cases may be embedded in an electronic system such as the head unit of a vehicle or an advanced driver assistance system (ADAS). Still further, a mobile-internet device (MID). Depending on the type, the user device can include one or more general-purpose processors, a computer-readable memory, a user interface, one or more network interfaces, one or more sensors, etc.

Various modifications to the implementations described in this disclosure may be readily apparent to persons having ordinary skill in the art, and the generic principles defined herein may be applied to other implementations without departing from the scope of this disclosure. Thus, the claims are not intended to be limited to the implementations shown herein but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

1. A method for synchronizing a data connection between a user equipment (UE) and a core network (CN), the method implemented in a node of the CN and comprising:
receiving, from the UE, a non-access stratum (NAS) request message; and
in response to determining to reject the NAS request, transmitting, to the UE, a status of the data connection at the CN.

2. The method of claim 1, wherein the transmitting of the status of the data connection includes:
transmitting, to the UE, a NAS reject message including the status of the data connection.

3. The method of claim 2, wherein:
the NAS request is a first NAS request;
the method further comprising, prior to receiving the first NAS request:
receiving, from the UE, a second NAS request; and
transmitting, to the UE and in response to the second NAS request message, a NAS accept message including an indication that the UE is allowed to perform data connection status synchronization using the NAS reject message.

4. The method of claim 2, further comprising, prior to receiving the NAS request message:
transmitting, to the UE, a mobility management (MM) NAS message including an indication that the UE is allowed to perform data connection status synchronization using the NAS reject message.

5. The method of claim 2, further comprising, prior to receiving the NAS request message:
transmitting, to the UE, a NAS Management Object (MO) message including an indication that the UE is allowed to perform data connection status synchronization using the NAS reject message.

6. The method of claim 1, wherein the transmitting of the status of the data connection includes:
transmitting, to the UE, a message associated with a NAS common procedure, the message including the status of the data connection.

7. The method of claim 1, wherein:
the NAS request message includes a UE status of the data connection;
the method further comprising:
updating, using the UE status of the data connection, the status of the data connection at the CN.

8. The method 7, wherein:
the UE status of the data connection indicates that the UE has released the data connection; the method further comprising:
releasing the data connection at the CN in response to receiving the UE status.

9. The method of claim 1, wherein:
the data connection is an Evolved Packet System (EPS) bearer.

10. The method of claim 9, wherein the transmitting of the status of the data connection includes:
transmitting an EPS bearer context status information element (IE).

11. The method of claim 1, wherein:
the data connection is a Packet Data Unit (PDU) session.

12. The method of claim 11, wherein the transmitting of the status of the data connection includes:
transmitting a PDU session status IE.

13. A method for synchronizing a data connection between a user equipment (UE) and a core network (CN), the method implemented in the UE and comprising:
transmitting, to the CN, a non-access stratum (NAS) request message;
receiving, from the CN and in response to the NAS request message, a NAS reject message including a status of the data connection at the CN; and
updating, using the status of the data connection received from the CN, a UE status of the data connection.

14. The method of claim 13, further comprising:
determining that the UE is allowed to perform data connection status synchronization using the NAS reject message.

15. The method of claim 14,
wherein the determining includes retrieving, from a Universal Subscriber Identity Module (USIM), an indication that the UE is allowed to perform the data connection status synchronization using the NAS reject message.

16. The method of claim 14,
wherein the determining includes retrieving, from a memory of the UE, a pre-configuration information.

17. The method of claim 14, wherein:
the NAS request message is a first NAS request message;
the method further comprising, prior to transmitting the NAS request message:
transmitting, to the CN, a second NAS request message; and
receiving, from the CN and in response to the second NAS request message, a NAS accept message including an indication that the UE is allowed to perform data connection status synchronization using the NAS reject message.

18. The method of claim 14, further comprising prior to transmitting the NAS request message:
receiving, from the CN, an MM NAS message including an indication that the UE is allowed to perform data connection status synchronization using the NAS reject message.

19. The method of claim 14, further comprising prior to transmitting the NAS request message:
receiving, from the CN, a NAS Management Object (MO) message including an indication that the UE is allowed to perform data connection status synchronization using the NAS reject message.

20. The method of claim 1,
wherein the updating of the UE status of the data connection using the status of the data connection received from the CN is response to determining that the NAS reject message is integrity-protected.

21-26. (canceled)
